(19) United States
(12) Patent Application Publication
(10) Pub. No.: US 2026/0101144 A1
(43) Pub. Date: Apr. 9, 2026

(54) SOUND OUTPUT DEVICES

(71) Applicant: SHENZHEN SHOKZHEAR CO., LTD., Shenzhen (CN)

(72) Inventors: Huifang TANG, Shenzhen (CN); Junjiang FU, Shenzhen (CN)

(73) Assignee: SHENZHEN SHOKZHEAR CO., LTD., Shenzhen (CN)

(21) Appl. No.: 19/417,437

(22) Filed: Dec. 12, 2025

Related U.S. Application Data
(63) Continuation of application No. PCT/CN2024/090656, filed on Apr. 29, 2024.

(51) Int. Cl. H04R 25/00; H04R 1/10

(52) U.S. Cl. CPC H04R 25/356; H04R 1/105; H04R 25/402; H04R 25/405; H04R 25/607; H04R 2225/0213; H04R 2410/07

(57) ABSTRACT

Provided is a sound output device. The sound output device includes a sound output unit, an ear hook, one or more microphones, and a processing circuit. The sound output unit includes a housing and a diaphragm disposed in the housing. A front cavity and a rear cavity are respectively provided on two sides of the diaphragm in the housing, the front cavity is acoustically coupled to a sound outlet hole provided on the housing, the sound outlet hole is disposed toward an ear canal of the user, and the rear cavity is acoustically coupled to a pressure relief hole provided on the housing. The ear hook includes a first portion located between an auricle and a head of a user, and a second portion extending toward a side of the auricle away from the head and connected to the sound output unit. The one or more microphones, disposed on the ear hook, are configured to collect an ambient sound to generate an electric signal. The processing circuit is configured to perform an amplifying processing on the electric signal generated by the one or more microphones, and send a processed electric signal to the sound output unit. At least one of the one or more microphones is located at the first portion of the ear hook, and a connecting line between the at least one of the one or more microphones and the sound outlet hole passes through the auricle.

### CROSS-REFERENCE TO RELATED APPLICATION

This application is a continuation of International Application No. PCT/CN2024/090656, filed on Apr. 29, 2024, the contents of which are incorporated herein by reference.

### TECHNICAL FIELD

The present disclosure relates to the field of acoustic technology, and in particular, to a sound output device.

### BACKGROUND

A sound output device with an auxiliary hearing function (e.g., a hearing aid) is defined as a tool, device, apparatus, and instrument used by hearing-impaired individuals to ameliorate hearing impairment, thereby enhancing their ability to communicate with others. A current type of the hearing aid mainly includes a behind-the-ear hearing aid and an in-the-ear hearing aid. The wearing comfort and output effect of the sound output device (e.g., the hearing aid) greatly affect user choice and experience.

Therefore, it is necessary to propose a sound output device to improve the wearing comfort of the user and the output effect of the sound output device.

### SUMMARY

One or more embodiments of the present disclosure provide a sound output device. The sound output device includes a sound output unit, an ear hook, one or more microphones, and a processing circuit. The sound output unit includes a housing and a diaphragm disposed in the housing. A front cavity and a rear cavity are respectively provided on two sides of the diaphragm in the housing. The front cavity is acoustically coupled to a sound outlet hole provided on the housing. The sound outlet hole is disposed toward an ear canal of a user. The rear cavity is acoustically coupled to a pressure relief hole provided on the housing. The ear hook includes a first portion and a second portion. The first portion is located between an auricle of the user and a head of the user, and the second portion extends toward a side of the auricle away from the head and is connected to the sound output unit, to the ear hook places the sound output unit near the ear canal without blocking an opening of the ear canal. The one or more microphones are disposed on the ear hook and configured to collect an ambient sound to generate an electric signal. The processing circuit is configured to perform an amplifying processing on the electric signal generated by the one or more microphones and send a processed electric signal to the sound output unit, and the sound output unit generates a sound under an action of the processed electric signal. At least one of the one or more microphones is located at the first portion of the ear hook, and a connecting line between the at least one of the one or more microphones and the sound outlet hole passes through the auricle.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same reference numerals denote the same structures.

FIG. 1 is a schematic diagram illustrating an exemplary ear according to some embodiments of the present disclosure;

FIG. 2 is a schematic diagram illustrating a sound output device in a wearing state according to some embodiments of the present disclosure;

FIG. 3 is a schematic diagram illustrating a sound output device in a wearing state according to some embodiments of the present disclosure;

FIG. 4 is a schematic diagram illustrating a sound output device in a wearing state according to some embodiments of the present disclosure;

FIG. 5 is a schematic diagram illustrating an exemplary projection of a sound output device on a sagittal plane of a user according to some embodiments of the present disclosure;

FIG. 6 is a schematic diagram illustrating an exemplary structure of a sound output device in a non-wearing state according to some embodiments of the present disclosure;

FIG. 7 is a schematic diagram illustrating an exemplary sound field distribution for sound pressure levels of a sound output unit according to some embodiments of the present disclosure;

FIG. 8A is a schematic diagram illustrating a relative position of a pressure relief hole, a sound outlet hole, and a first microphone from a perspective according to some embodiments of the present disclosure;

FIG. 8B is a schematic diagram illustrating a relative position of a pressure relief hole, a sound outlet hole, and a first microphone from another perspective according to some embodiments of the present disclosure;

FIG. 9 is a schematic diagram illustrating a cross-section of an ear hook at a first microphone according to some embodiments of the present disclosure;

FIG. 10 is a schematic diagram illustrating an internal structure of a sound output unit according to some embodiments of the present disclosure;

FIG. 11 is a schematic diagram illustrating directivity of a sound output unit according to some embodiments of the present disclosure; and

FIG. 12 is a schematic diagram illustrating another sound field distribution for sound pressure levels of a sound output unit according to some embodiments of the present disclosure.

### DETAILED DESCRIPTION

To more clearly illustrate the technical solutions of the embodiments of the present disclosure, a brief introduction will be made to the accompanying drawings used in the description of the embodiments. Obviously, the drawings in the following description are only some examples or embodiments of the present disclosure, and for those of ordinary skill in the art, without creative labor, the present disclosure can be applied to other similar scenarios based on these drawings. Unless obvious from the context or otherwise stated, the same reference numerals in the drawings denote the same structures or operations.

It should be understood that the terms “system”, “device”, “unit”, and/or “module” used herein are a manner for distinguishing different components, elements, parts, sections, or assemblies of different levels. However, if other words can achieve the same purpose, the words may be replaced by other expressions.

As shown in the present disclosure and the claims, unless the context clearly indicates an exception, the words “a”, “an”, “one”, and/or “the” are not specifically limited to singular and may also include plural. Generally, the terms “comprise” and “include” only indicate including explicitly identified steps and elements, these steps and elements do not constitute an exclusive list, and the manner or device may also contain other steps or elements.

The present disclosure uses flowcharts to illustrate the operations performed by the system according to the embodiments of the present disclosure. It should be understood that the preceding or following operations are not necessarily performed precisely in sequence. Instead, the steps can be processed in reverse order or simultaneously. At the same time, other operations can be added to these processes, or one or more operations can be removed from these processes.

A sound output device with an auxiliary hearing function, such as a hearing aid, mainly includes a microphone collecting external sounds, a processing circuit processing signals, a speaker outputting sounds, etc. A signal collected by the microphone is sent to the speaker after being processed (e.g., amplified) by the processing circuit, and the speaker plays the sound to a user. In some situations, the microphone may collect the sound played by the speaker, and the processing circuit amplifies the sound and sends the sound to the speaker again for playback, thereby forming an echo, resulting in poor output effect of the hearing aid.

Current types of the hearing aid mainly include a behind-the-ear hearing aid and an in-the-ear hearing aid, and the behind-the-ear hearing aid includes an in-ear hearing aid and an open-fit hearing aid, etc. The in-the-ear hearing aid is disposed in the ear canal of the user, and the in-ear hearing aid blocks an opening of the ear canal when worn, both of which reduce the user's wearing comfort during prolonged wear. However, for the in-the-ear hearing aid and the in-ear hearing aid, the speaker is located in the ear canal of the user in a wearing state, and the microphone is located outside the ear canal. The sound generated by the speaker is isolated by the ear canal of the user, making it less susceptible to being picked up by the speaker, less prone to produce an echo, resulting in a better output effect. The open-fit hearing aid does not block the opening of the ear canal, and has higher wearing comfort. However, a sound transmission path is easily formed between the speaker and the microphone of the open-fit hearing aid, thereby generating a large echo, leading to a poor output effect.

To solve the above problems, some embodiments of the present disclosure provide an open sound output device, which mainly includes a sound output unit, an ear hook, one or more microphones, and a processing circuit. The microphone may collect an external sound signal and generate an electric signal. The processing circuit may process and amplify the electric signal, and the sound output unit outputs a sound based on an amplified electric signal. The ear hook includes a first portion located between an auricle and a head of a user and a second portion extending toward a side of the auricle away from the head and connected to the sound output unit. The ear hook may place the sound output unit near an ear canal of the user without blocking an opening of the ear canal, thereby improving the wearing comfort of the sound output device. Furthermore, at least one of the one or more microphones is located at the first portion of the ear hook, and a connecting line between the at least one of the one or more microphone and a sound outlet hole on a housing of the sound output unit passes through the auricle of the user. By placing the auricle between the sound outlet hole and the microphone, the sound output by the sound output unit is blocked by the auricle, reducing the sound output by the sound output unit that is received by the microphone, reducing the impact of the sound output by the sound output unit on the microphone, reducing the generation of the echo, and at the same time, the auricle can block wind, reducing the wind noise received by the microphone, thereby improving the output effect of the sound output device.

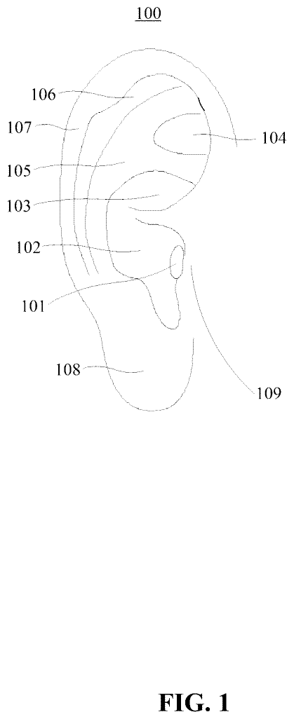

FIG. 1 is a schematic diagram illustrating an exemplary ear according to some embodiments of the present disclosure.

As shown in FIG. 1, an ear 100 may include an ear canal 101, a concha cavity 102, a cymba conchae 103, a triangular fossa 104, an antihelix 105, a scaphoid fossa 106, a helix 107, an earlobe 108, and a tragus 109. In some embodiments, an auricle may be a general term for other external ear portions of the ear 100, except for the ear canal 101. For example, as shown in FIG. 1, the auricle may include the concha cavity 102, the cymba conchae 103, the triangular fossa 104, the antihelix 105, the scaphoid fossa 106, the helix 107, the earlobe 108, and the tragus 109. It should be noted that, for ease of description, in the embodiments of the present disclosure, a superior crus of the antihelix, an inferior crus of the antihelix, and the antihelix 105 are collectively referred to as an antihelix region. In some embodiments, the stability of the sound output device when worn can be achieved by utilizing support from one or more portions of the ear 100. In some embodiments, portions such as the ear canal 101, the concha cavity 102, the cymba conchae 103, the triangular fossa 104, etc., have a certain depth and volume in a three-dimensional space, which may be used to meet the wearing requirements of the sound output device. For example, the sound output device (e.g., an in-ear hearing aid) may be worn in the ear canal 101. In some embodiments, the wearing of the sound output device can be achieved by utilizing other portions of the ear 100 besides the ear canal 101. For example, the wearing of the sound output device can be achieved by utilizing portions such as the cymba conchae 103, the triangular fossa 104, the antihelix 105, the scaphoid fossa 106, or the helix 107, or a combination thereof. In some embodiments, to improve the comfort and reliability of the sound output device in terms of wearing, portions such as the earlobe 108 may also be further utilized. By utilizing the other portions of the ear 100 besides the ear canal 101 to achieve the wearing of the sound output device and the propagation of sounds, the ear canal 101 of the user can be “liberated”. In some embodiments, the sound output device may be designed to have a structure adapted to the structure of the ear 100 to achieve the wearing of the sound output unit of the sound output device at different positions of the ear 100. For example, when the sound output device is the open-fit hearing aid, the open-fit hearing aid may include the ear hook and the sound output unit, the sound output unit is physically connected to the ear hook, and the ear hook may be adapted to a shape of the auricle to place the whole or a portion of the sound output unit at an upper region of the tragus (e.g., at a position of one or more portions such as the tragus 109, the cymba conchae 103, the triangular fossa 104, the antihelix 105, the scaphoid fossa 106, the helix 107, etc.). As another example, when the user wears the open-fit hearing aid, a whole or a portion of the structure of the sound output unit may be located in a cavity formed by one or more portions of the ear 100 (e.g., the concha cavity 102, the cymba conchae 103, the triangular fossa 104, etc.).

Different users may have individual differences, leading to variations in the shape, size, and other dimensions of the ear 100. For ease of description and understanding, unless otherwise specified, the present disclosure will primarily use an ear model with a “standard” shape and size as a reference to further describe a wearing manner of the sound output device in different embodiments on the ear model. For example, a simulator containing a head and its (left, right) ears 100 manufactured based on standards ANSI: S3.36, S3.25, and IEC: 60318-7, such as GRAS 45BC KEMAR, HEAD Acoustics, B&K 4128 series, or B&K 5128 series, may be used as the reference for wearing the sound output device, thereby presenting scenarios where most users normally wear the sound output device. Taking GRAS KEMAR as an example, an ear simulator may be any one of GRAS 45AC, GRAS 45BC, GRAS 45CC, GRAS 43AG, etc. Taking HEAD Acoustics as an example, the ear simulator may be any one of HMS II.3, HMS II.3 LN, HMS II.3LN HEC, etc. It should be noted that data ranges measured in the embodiments of the present disclosure are obtained based on GRAS 45BC KEMAR, but it should be understood that there may be differences between different head models and ear models, and relevant data ranges may fluctuate by ±10% when using other models. Merely by way of example, a referenced ear 100 may have the following relevant characteristics: a size of a projection of the auricle on a sagittal plane in a direction of an vertical axis may be in a range of 49.5 mm to 74.3 mm, and a size of the projection of the auricle on the sagittal plane in a direction of a sagittal axis may be in a range of 36.6 mm to 55 mm. Therefore, in the present disclosure, descriptions such as “user wearing,” “worn,” and “in the wearing state” refer to the sound output device described in the present disclosure being worn on the ear 100 of the simulator. Of course, considering the individual differences of the different users, a structure, a shape, a size, a thickness, etc., of one or more portions in the ear 100 may be differentially designed according to ears 100 of different shapes and sizes. These differential designs may be reflected in that characteristic parameters of one or more portions in the sound output device (e.g., the sound output unit, the ear hook, etc., mentioned below) may have values in different ranges to adapt to different ears 100. Additionally, it should be noted that “non-wearing state” is not limited to a state where the sound output device is not worn on the ear 100, but also includes a state where the sound output device is not deformed by external forces; “wearing state” is not limited to a state where the sound output device is worn on the ear 100, and the ear hook and the sound output unit being separated to a corresponding distance may also be regarded as the wearing state.

It should be noted that in fields such as medicine and anatomy, three basic planes of a human body are defined: the sagittal plane, a coronal plane, and a horizontal plane, as well as three basic axes: the sagittal axis, a coronal axis, and the vertical axis. The sagittal plane refers to a plane perpendicular to the ground made along an anterior-posterior direction of the body, which divides the body into left and right portions. The coronal plane refers to a plane perpendicular to the ground made along a left-right direction of the body, which divides the body into anterior and posterior portions. The horizontal plane refers to a plane parallel to the ground made along a superior-inferior direction of the body, which divides the body into upper and lower portions. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Furthermore, “a front side of the ear” described in the present disclosure is a concept relative to “a rear side of the ear”. The front side of the ear refers to a side along a direction of the sagittal axis and located where the ear 100 faces a facial region of the human body, and the back side of the ear refers to a side along a direction of the sagittal axis and located where the ear 100 faces away from the facial region of the human body. Observing the ear 100 of the simulator along a direction of the coronal axis of the human body, a schematic diagram illustrating a front side contour of the ear 100 shown in FIG. 1 may be obtained.

The description of the ear 100 is for illustrative purposes only and is not intended to limit the scope of the present disclosure. For those of ordinary skill in the art, various changes and modifications may be made based on the description of the present disclosure. For example, a portion of the sound output device may obscure a portion or all of the ear canal 101. These changes and modifications still fall within the protection scope of the present disclosure.

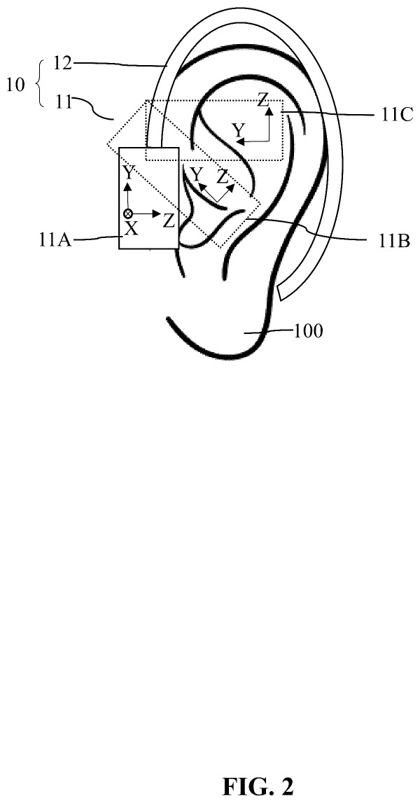

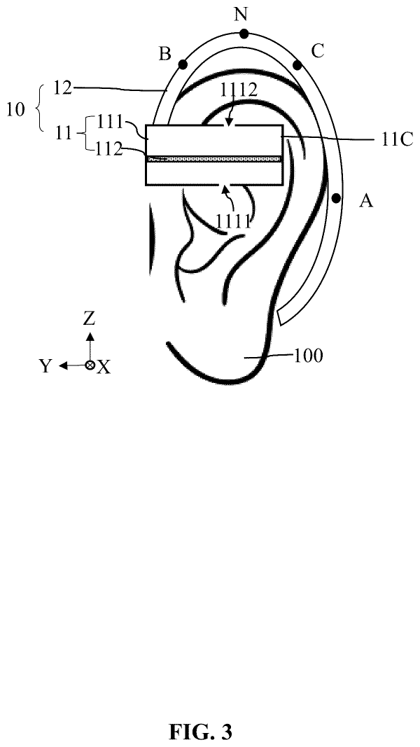

FIG. 2 is a schematic diagram illustrating a sound output device in a wearing state according to some embodiments of the present disclosure. FIG. 3 is a schematic diagram illustrating a sound output device in a wearing state according to some embodiments of the present disclosure. As shown in FIGS. 2 and 3, a sound output device 10 may include a sound output unit 11, an ear hook 12, one or more microphones disposed on the ear hook 12 (e.g., a point A, or points B and C shown in FIG. 3) and a processing circuit (not shown in the figure). In some embodiments, the sound output device 10 may be worn on the user's body (e.g., the head, neck, or upper torso of the human body) through the ear hook 12, while the sound output unit 11 may be close to the ear canal of the user without blocking an opening of the ear canal, so that the ear 100 remains in an open state, improving the wearing comfort of the sound output device 10. The one or more microphones may collect an ambient sound and generate an electric signal, the processing circuit may perform an amplifying processing on the electric signal generated by the one or more microphones, and the sound output unit 11 generates a sound under an action of an amplified electric signal.

In some embodiments, the sound output unit 11 may include a housing 111 and a diaphragm 112 disposed in the housing 111. The housing 111 may be used for being worn on the user's body and may carry the diaphragm 112. In some embodiments, the housing 111 may be an internally hollow enclosed shell structure, and the diaphragm 112 is located inside the housing 111. In some embodiments, the housing 111 may be a shell structure adapted to a shape of the ear 100, such as circular, elliptical, polygonal (regular or irregular), U-shaped, V-shaped, semicircular, etc., so that the housing 111 may be directly located onto the ear 100. In some embodiments, the housing 111 may further include a fixing structure. Merely by way of example, the fixing structure may be an ear hook, an elastic band, etc., so that the sound output device 10 can be better worn on the user and prevent the user from dropping it during use.

In some embodiments, when the user wears the sound output device 10, the sound output unit 11 may be located above, below, at the front side (e.g., a front side of the tragus) of the ear 100, or inside the auricle (e.g., in the concha cavity).

In some embodiments, when the diaphragm 112 vibrates, sounds may be output from a front side of the diaphragm 112 and a rear side of the diaphragm 112, respectively. A position on the front side of the diaphragm 112 within the housing 111 is provided with a front cavity (not labeled in the figure) for transmitting a sound, and a position on the rear side of the diaphragm 112 within the housing 111 is provided with a rear cavity (not labeled in the figure) for transmitting a sound. The housing 111 may also be provided with a sound outlet hole 1111 acoustically coupled to the front cavity and a pressure relief hole 1112 acoustically coupled to the rear cavity. The sound from the front side of the diaphragm 112 may be output from the sound outlet hole 1111 through the front cavity, and the sound from the rear side of the diaphragm 112 may be output from the pressure relief hole 1112 through the rear cavity. In some embodiments, the diaphragm 112 in the sound output unit 11 may output a set of sounds with a phase difference (e.g., opposite phases) through the sound outlet hole 1111 and the pressure relief hole 1112. When the diaphragm 112 vibrates, the front side and the rear side of the diaphragm 112 may simultaneously produce the set of sounds with the phase difference (e.g., the opposite phases). After the sounds pass through the front cavity and the rear cavity respectively, they propagate outward from the positions of the sound outlet hole 1111 acoustically coupled to the front cavity and the pressure relief hole 1112 acoustically coupled to the rear cavity. In some embodiments, the sound outlet hole 1111 may be located on an inner side wall (e.g., an inner side surface IS) of the housing 111 of the sound output unit 11 facing the ear canal 101 of the user, and the pressure relief hole 1112 may be located on a side (e.g., an outer side surface OS) of the housing 111 of the sound output unit 11 away from the ear canal 101 of the user.

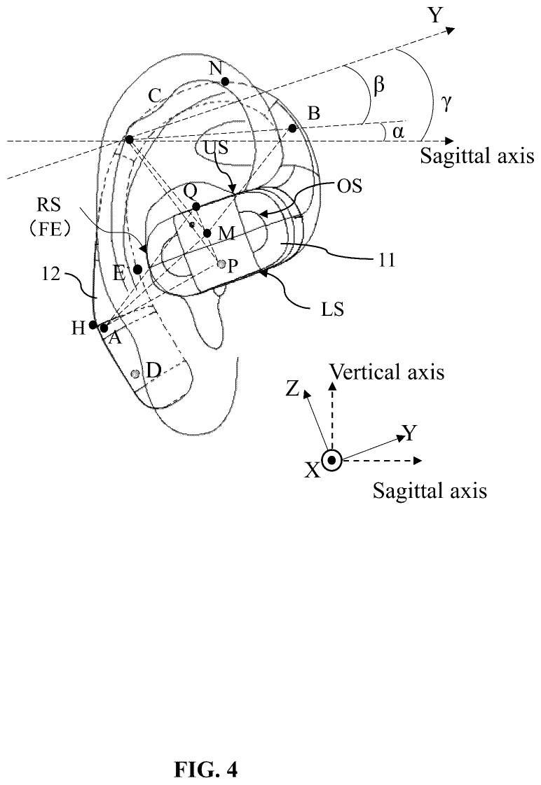

With reference to FIGS. 1, 2, and 3, 11A, 11B, and 11C in FIG. 2 respectively represent schematic diagrams of different positional states of the sound output unit 11 in the wearing state, and FIG. 3 is a schematic diagram when the sound output unit 11 is at a position shown by 11C in the wearing state. In some embodiments, when the user wears the sound output device 10, at least a portion of the sound output unit 11 may be located in a front side region of the tragus of the ear 100 or in a front outer side surface of the auricle. The following will provide an exemplary explanation in conjunction with the sound output unit 11 at different wearing positions (e.g., a sound output unit 11A, a sound output unit 11B, and a sound output unit 11C). It should be noted that the front outer side surface of the auricle mentioned in the embodiments of the present disclosure refers to a side of the auricle away from the head along the direction of the coronal axis, and correspondingly, a back inner side surface of the auricle refers to a side of the auricle facing the head along the direction of the coronal axis. In some embodiments, the sound output unit 11A is located on the side of the ear 100 facing the facial region of the human body along the direction of the sagittal axis, i.e., the sound output unit 11A is located in the facial region at the front side of the ear 100. Furthermore, the housing of the sound output unit 11A is internally provided with the diaphragm 112, the housing 111 of the sound output unit 11A may be provided with at least one sound outlet hole 1111, the at least one sound outlet hole 1111 may be located on a side wall of the housing 111 of the sound output unit 11 facing or close to the ear canal 101 of the user, and the diaphragm 112 may output sound to the ear canal 101 of the user through the at least one sound outlet hole 1111. In some embodiments, the sound output unit 11 may have a long axis direction Y and a short axis direction Z that are perpendicular to a thickness direction X and orthogonal to each other. The long axis direction Y refers to a direction with a largest extension dimension in a shape of a two-dimensional projection plane of the sound output unit 11 (e.g., a projection of the sound output unit 11 on a plane where its outer side surface lies, or a projection of the sound output unit 11 on the sagittal plane), for example, when a projection shape is rectangular or approximately rectangular, the long axis direction is a length direction of the rectangle or approximate rectangle. The short axis direction Z refers to a direction perpendicular to the long axis direction Y in a shape of the projection of the sound output unit 11 on the sagittal plane. For example, when the projection shape is rectangular or approximately rectangular, the short axis direction is a width direction of the rectangle or approximate rectangle. The thickness direction X refers to a direction perpendicular to the two-dimensional projection plane, for example, the thickness direction X is consistent with the direction of the coronal axis, both indicating the left-right direction of the human body. In some embodiments, the thickness direction X also refers to a direction in which the sound output unit 11 approaches or moves away from the ear 100 in the wearing state. In some embodiments, when the sound output unit 11 is in an inclined state in the wearing state, the long axis direction Y and the short axis direction Z are still parallel or approximately parallel to the sagittal plane, the long axis direction Y may have a certain angle with the direction of the sagittal axis, that is, the long axis direction Y is also correspondingly inclined, and the short axis direction Z may have a certain angle with the direction of the vertical axis, that is, the short axis direction Z is also inclined, as shown in the wearing situation of the sound output unit 11B in FIG. 2. In some embodiments, the whole or a portion of the housing 111 of the sound output unit 11B may extend into the concha cavity 102, that is to say, a projection of the housing 111 of the sound output unit 11B on the sagittal plane has an overlapping portion with a projection of the concha cavity 102 on the sagittal plane. For specific content about the sound output unit 11B, reference may be made to other portions of the present disclosure, such as FIG. 4 and related descriptions thereof. In some embodiments, the sound output unit 11 may also be in a horizontal state or an approximately horizontal state in the wearing state, as shown by the sound output unit 11C in FIGS. 2 and 3, the long axis direction Y may be consistent or approximately consistent with the direction of the sagittal axis, both indicating the anterior-posterior direction of the human body. The short axis direction Z may be consistent or approximately consistent with the direction of the vertical axis, both indicating the superior-inferior direction of the human body. It should be noted that, in the wearing state, the sound output unit 11C being in the approximately horizontal state may mean that an angle between the long axis direction Y of the sound output unit 11C shown in FIG. 2 and the sagittal axis is within a specific range (e.g., not greater than 20°). Furthermore, the wearing position of the sound output unit 11 is not limited to the sound output unit 11A, the sound output unit 11B, and the sound output unit 11C shown in FIG. 2, as long as the at least a portion of the sound output unit 11 is located in the front side region of the tragus of the ear 100 or in the front outer side surface of the auricle. For example, the whole or a portion of the sound output unit 11 may be located at the front side of the tragus 109. As another example, the whole or a portion of the sound output unit 11 may contact an upper region of the ear canal 101 (e.g., at the position of one or more portions such as the tragus 109, the cymba conchae 103, the triangular fossa 104, the antihelix 105, the scaphoid fossa 106, the helix 107, etc., are located). As another example, the whole or a portion of the sound output unit 11 may be located in a cavity formed by the one or more portions of the ear 100 (e.g., the concha cavity 102, the cymba conchae 103, the triangular fossa 104, etc.).

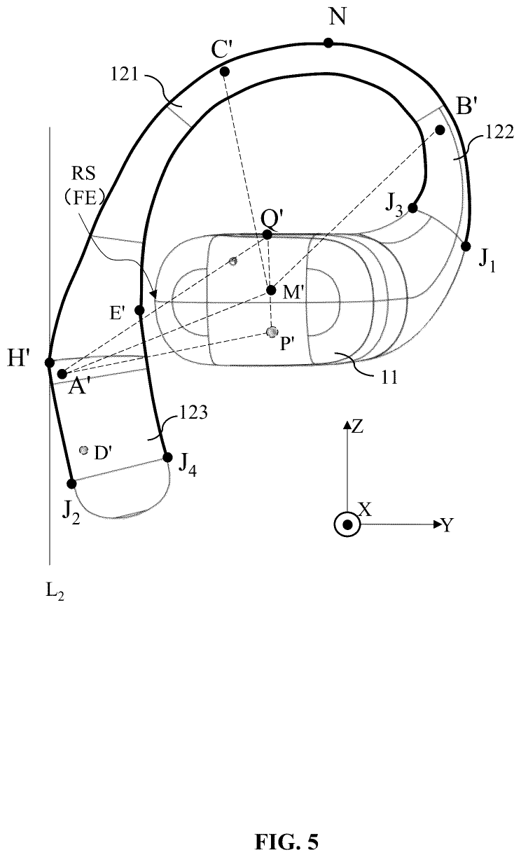

In some embodiments, in the wearing state, the ear hook 12 includes a first portion 121 and a second portion 122 (as shown in FIG. 5). The first portion 121 is located between the auricle and the head of the user, and the second portion 122 extends toward a side of the auricle away from the head and is connected to the sound output unit 11, to the ear hook 12 places the sound output unit 11 near the ear canal without blocking the opening of the ear canal.

In some embodiments, the first portion 121 of the ear hook 12 includes an accommodation cavity 123. The processing circuit may be disposed in the accommodation cavity 123, and the accommodation cavity 123 may protect the processing circuit. In some embodiments, the accommodation cavity 123 is located at an end of the first portion 121 away from the sound output unit 11, and a projection contour of an end of the ear hook 12 away from the sound output unit 11 is a projection contour of a free end of the accommodation cavity 123 on the sagittal plane. In some embodiments, when the user wears the sound output device 10, the sound output unit 11 and the accommodation cavity 123 may be located at the front side and the back side of the auricle, respectively.

To improve the stability of the sound output device 10 in the wearing state, the sound output device 10 may adopt any one or a combination of the following manners. First, at least a portion of the ear hook 12 is configured as a contour-conforming structure that fits with at least one of the back side of the ear and the head, to increase a contact area between the ear hook 12 and the ear 100 and/or the head, thereby increasing a resistance to the sound output device 10 falling off from the ear 100. Second, the at least a portion of the ear hook 12 is configured as an elastic structure, so that it has a certain amount of deformation in the wearing state, to increase a positive pressure of the ear hook 12 on the ear 100 and/or the head, thereby increasing the resistance to the sound output device 10 falling off from the ear 100. Third, the at least a portion of the ear hook 12 is configured to abut against the head in the wearing state, so that it forms a reaction force pressing against the ear 100, so that the sound output unit 11 is pressed against the front side of the ear, thereby increasing the resistance to the sound output device 10 falling off from the ear 100. Fourth, the sound output unit 11 and the ear hook 12 are configured to clamp the antihelix region, a region where the concha cavity 102 is located, etc., from the front and back sides of the ear 100 in the wearing state, thereby increasing the resistance to the sound output device 10 falling off from the ear 100. Fifth, the sound output unit 11 or an auxiliary structure connected thereto is configured to extend at least portionially into cavities such as the concha cavity 102, the cymba conchae 103, the triangular fossa 104, and the scaphoid fossa 106, thereby increasing the resistance to the sound output device 10 falling off from the ear 100.

Exemplarily, with reference to FIG. 4, in the wearing state, a free end FE of the sound output unit 11 may extend into the concha cavity 102. The sound output unit 11 and the ear hook 12 may be configured to jointly clamp an ear region from the front and back sides of the ear region corresponding to the concha cavity 102, thereby increasing the resistance to the sound output device 10 falling off from the ear 100, and thus improving the stability of the sound output device 10 in the wearing state. For example, the free end FE is pressed within the concha cavity 102 in the thickness direction X. As another example, the free end FE abuts within the concha cavity 102 in the long axis direction Y and the short axis direction Z.

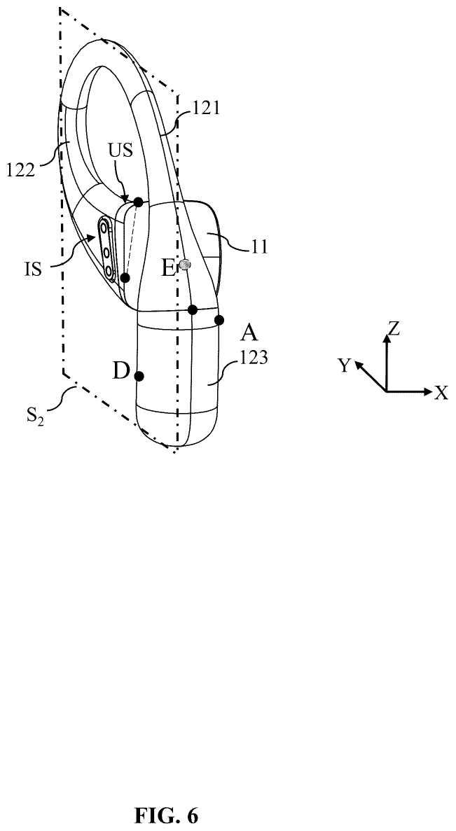

FIG. 4 is a schematic diagram illustrating a sound output device in a wearing state according to some embodiments of the present disclosure. FIG. 5 is a schematic diagram illustrating an exemplary projection of a sound output device on a sagittal plane of a user according to some embodiments of the present disclosure. FIG. 6 is a schematic diagram illustrating an exemplary structure of a sound output device in a non-wearing state according to some embodiments of the present disclosure. Points A′, B′, C′, D′, E′, P′, Q′, M′, and H′ in FIG. 5 are projection points on the sagittal plane of points A, B, C, D, E, P, Q, M, and H shown in FIG. 4, respectively.

In some embodiments, please refer to FIGS. 4, 5, and 6, the sound output unit 11 may have an inner side surface IS facing the ear along the thickness direction X in the wearing state, an outer side surface OS away from the ear, and a connecting surface connecting the inner side surface IS and the outer side surface OS. It should be noted that: in the wearing state, when viewed along the direction of the coronal axis (i.e., the thickness direction X), the sound output unit 11 may be configured in a shape such as circular, elliptical, rounded square, rounded rectangle, etc. When the sound output unit 11 is configured in the shape such as circular or elliptical, the connecting surface refers to a curved side surface of the sound output unit 11. When the sound output unit 11 is configured in the shape such as a rounded square or a rounded rectangle, the connecting surface may include a lower side surface LS, an upper side surface US, and a rear side surface RS mentioned later. Therefore, for ease of description, this embodiment uses the sound output unit 11 configured as the rounded rectangle as an example for illustrative description. A length of the sound output unit 11 in the long axis direction Y may be greater than a width of the sound output unit 11 in the short axis direction Z. As shown in FIG. 3, the sound output unit 11 may have the upper side surface US away from the ear canal 101 along the short axis direction Z in the wearing state, the lower side surface LS facing the ear canal 101, and the rear side surface RS connecting the upper side surface US and the lower side surface LS. The rear side surface RS is located at an end of the long axis direction Y facing the back of the head in the wearing state and is at least portionially located in the concha cavity 102. In some embodiments, the rear side surface RS of the sound output unit 11 is the free end FE of the sound output unit 11.

In some embodiments, the sound outlet hole 1111 may be disposed on the inner side surface IS of the sound output unit 11, and the pressure relief hole 1112 may be disposed on the upper side surface US of the sound output unit 11. In some embodiments, the point P as a centroid of the sound outlet hole 1111 may be used to represent a position of the sound outlet hole 1111, and the point Q as a centroid of the pressure relief hole 1112 may be used to represent a position of the pressure relief hole 1112, as shown in FIG. 4 to FIG. 6. In some embodiments, a direction of a connecting line PQ to the opening of the ear canal improves the directivity of the sound output unit 11. In some embodiments, when there are a plurality of sound outlet holes 1111, the point P may be understood as a centroid of an equivalent hole portion formed by the plurality of sound outlet holes 1111; when there are a plurality of pressure relief holes 1112, the point Q may be understood as a centroid of an equivalent hole portion formed by the plurality of pressure relief holes 1112. In some embodiments, a position of the equivalent hole portion formed by a plurality of hole portions may be determined by the following manner: sequentially connecting center points of adjacent hole portions to form a polygon or a polyhedron, and a centroid of the polygon or the polyhedron is the center point of the equivalent hole portion, which may be used to represent the position of the equivalent hole portion.

In some embodiments, when the diaphragm 112 vibrates, the front and rear sides of the diaphragm 112 may respectively act as a sound wave generating structure, producing sound waves with equal amplitude and opposite phases. In some embodiments, the sound waves with equal amplitude and opposite phases may be radiated outward through the sound outlet hole 1111 and the pressure relief hole 1112, respectively, forming a dual sound source. The dual sound source may cause destructive interference at a spatial point (e.g., in a far field), thereby reducing the far-field sound leakage of the sound output unit 11.

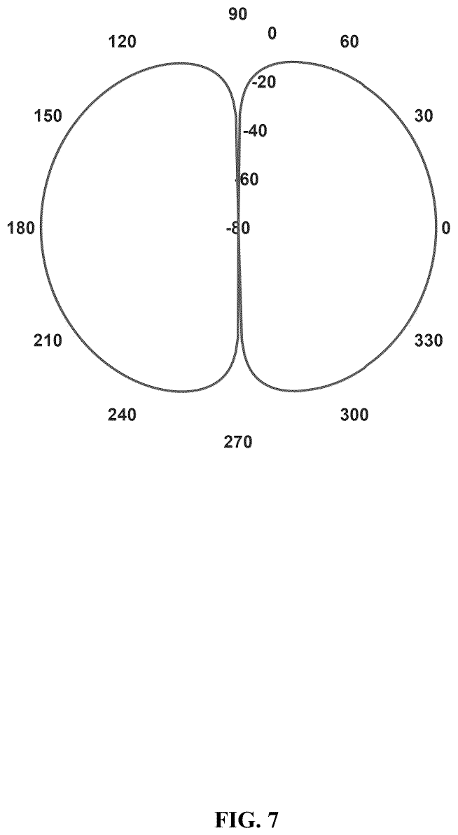

FIG. 7 is a schematic diagram illustrating an exemplary sound field distribution for sound pressure levels of a sound output unit according to some embodiments of the present disclosure. As shown in FIG. 7, in a mid-to-low frequency range (e.g., 50 Hz to 1 kHz), the sound field distribution of the sound output unit 11 exhibits good dual sound source directivity. That is to say, in the mid-to-low frequency range, the dual sound source composed of the sound outlet hole 1111 and the pressure relief hole 1112 of the sound output unit 11 outputs sound waves with opposite phases, and the sound field forms a distribution of two lobe-shaped structures in space. In two opposite directions of a connecting line of the dual sound source (i.e., two opposite directions on the connecting line PQ, the 0° direction and the 180° direction in FIG. 7), the sound pressure level is larger, which is a high sound leakage region. In a direction perpendicular to the connecting line of the dual sound source (i.e., a vertical direction of the connecting line PQ, the 90° direction, and the 270° direction in FIG. 7), the sound pressure level is smaller, which is a low sound leakage region.

In some embodiments, at least one of the one or more microphones (hereinafter referred to as at least one microphone) is located at the first portion 121 of the ear hook 12, such as, at the point A or the point C shown in FIG. 4. A connecting line between the at least one microphone and the sound outlet hole 1111 passes through the auricle of the user, for example, a connecting line AP and a connecting line CP shown in FIG. 4 pass through the auricle of the user. By placing the auricle between the sound outlet hole 1111 and the microphone, the sound output by the sound output unit 11 is blocked by the auricle, reducing the sound output by the sound output unit 11 that is received by the microphone, reducing the impact of the sound output by the sound output unit 11 on the microphone, reducing the generation of the echo, and at the same time, the auricle can block wind, reducing the wind noise received by the microphone, thereby improving the output effect of the sound output device 10.

In some embodiments, the one or more microphones may include or even only include a first microphone (not shown in the figure). The first microphone may collect an ambient sound and generate an electric signal. The diaphragm 112 vibrates to generate a sound based on the electric signal processed by the processing circuit.

In some embodiments, to reduce the impact of the sound output by the sound output unit 11 on the first microphone, to reduce the generation of the echo, and to improve the output effect of the sound output device 10, the sound output by the sound output unit 11 that is received by the first microphone may be minimized. For example, the first microphone may be located at the point A.

In some embodiments, in addition to setting an interval (the auricle) between the first microphone and the sound output unit 11, the sounds output by the sound outlet hole 1111 and the pressure relief hole 1112 of the sound output unit 11 can be made to cancel each other out at the first microphone, to reduce the sound output by the sound output unit 11 that is collected by the first microphone, thereby reducing the generation of the echo and improving the output effect of the sound output device 10. That is to say, the first microphone should be placed in the low sound leakage region of the sound output unit 11, such as a region near the 90° direction and the 270° direction in FIG. 7, so that a difference in sound pressure levels of the sounds output by the sound outlet hole 1111 and the pressure relief hole 1112 of the sound output unit 11 at the first microphone is small (e.g., less than 3 dB). To achieve this, a distance from the first microphone to the point P (the centroid of the sound outlet hole 1111), i.e., a length of the connecting line AP, and a distance from the first microphone to the point Q (the centroid of the pressure relief hole 1112), i.e., a length of the connecting line AQ, may be close or equal, so that acoustic paths from the sound outlet hole 1111 and the pressure relief hole 1112 to the first microphone are close, allowing the sounds output by the sound outlet hole 1111 and the pressure relief hole 1112 to cancel each other out at the first microphone. In some embodiments, a ratio of the distance from the first microphone to the point P (the centroid of the sound outlet hole 1111), i.e., a length of the connecting line AP, to the distance from the first microphone to the point Q (the centroid of the pressure relief hole 1112), i.e., a length of the connecting line AQ, is in a range of 0.8 to 1.2. In some embodiments, to further reduce the generation of the echo, the difference between the distance from the first microphone to the point P (the centroid of the sound outlet hole 1111), i.e., a length of the connecting line AP, and the distance from the first microphone to the point Q (the centroid of the pressure relief hole 1112), i.e., a length of the connecting line AQ, may be less than 5 mm.

Please continue to refer to FIG. 7, the sound field of the sound output unit 11 forms the distribution of two lobe-shaped structures in space. In the two opposite directions of the connecting line of the dual sound source (i.e., the two opposite directions on the connecting line PQ), the sound pressure level is larger, which is the high sound leakage region. In the direction perpendicular to the connecting line of the dual sound source (i.e., the vertical direction of the connecting line PQ), the sound pressure level is smaller, which is the low sound leakage region. To reduce the sound output by the sound output unit 11 that is collected by the first microphone, the first microphone may be set in the low sound leakage region, that is, the first microphone may be set near the 90° direction or the 270° direction of the sound field of the sound output unit 11. In some embodiments, considering the structure and positional arrangement of the ear hook 12 and the sound output unit 11, when the sound outlet hole 1111 is located at 0° direction, the pressure relief hole 1112 is located at 180° direction, and the first portion 121 is located on a side where a connecting line between the pressure relief hole 1112 and the sound outlet hole 1111 points to the 270° direction, the first microphone may be set near the 270° direction.

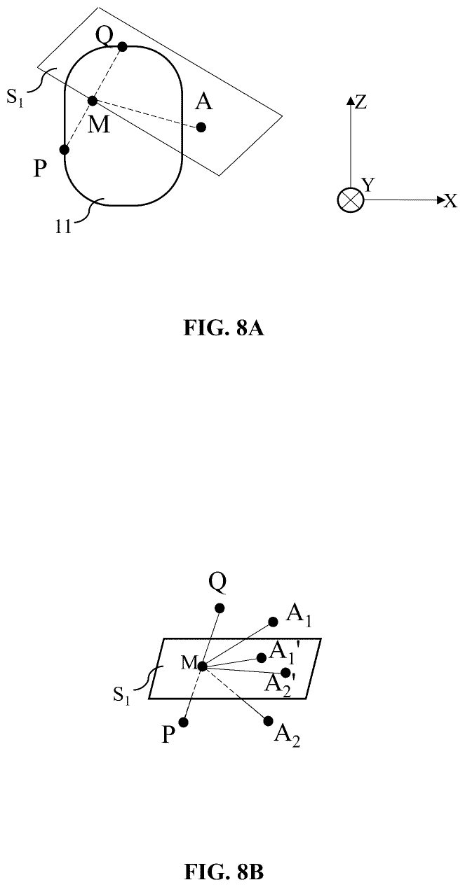

FIG. 8A is a schematic diagram illustrating a relative position of a pressure relief hole, a sound outlet hole, and a first microphone from a perspective according to some embodiments of the present disclosure. FIG. 8B is a schematic diagram illustrating a relative position of a pressure relief hole, a sound outlet hole, and a first microphone from another perspective according to some embodiments of the present disclosure. Please refer to FIGS. 5, 6, 8A, and 8B, the connecting line PQ between the point P (the centroid of the sound outlet hole 1111) and the point Q (the centroid of the pressure relief hole 1112) has a midpoint point M, and the connecting line PQ has a perpendicular bisector plane S₁ passing through the midpoint point M. FIG. 8A is a view from the free end FE of the sound output unit 11 towards a connection end where the sound output unit 11 is connected to the ear hook 12. FIG. 8B shows a relative position between the first microphone (the point A) and the perpendicular bisector plane S₁.

In some embodiments, an angle between a connecting line between the midpoint M and the first microphone (i.e., the point A) and the perpendicular bisector plane S₁ is in a range of −60° to 60°, so that the first microphone is located in the low sound leakage region of the sound output unit 11, reducing the sound of the sound output unit 11 that is collected by the first microphone, reducing the generation of the echo, and improving the output effect of the sound output device 10. In some embodiments, to further reduce the echo, the angle between the connecting line between the midpoint M and the first microphone (i.e., the point A) and the perpendicular bisector plane S₁ may be in a range of −30° to 30°. In some embodiments, to further reduce the echo, the angle between the connecting line between the midpoint M and the first microphone (i.e., the point A) and the perpendicular bisector plane S₁ may be in a range of −10° to 10°.

In some embodiments, a positive or negative value of the angle between the connecting line between the midpoint M and the first microphone (i.e., the point A) and the perpendicular bisector plane S₁ may indicate which side of the perpendicular bisector plane S₁ the first microphone (i.e., the point A) is located on. Exemplarily, please refer to FIG. 8B, when the first microphone is located on a side of the perpendicular bisector plane S₁ close to the pressure relief hole 1112 (i.e., the point Q), the first microphone may correspond to a point A₁, a projection of the point A₁ on the perpendicular bisector plane S₁ is a point A₁′, and the angle between the connecting line between the midpoint M and the first microphone (i.e., the point A₁) and the perpendicular bisector plane S₁ (i.e., an angle ∠A₁MA₁′) may have a positive value. When the first microphone is located on a side of the perpendicular bisector plane S₁ close to the sound outlet hole 1111 (i.e., the point P), the first microphone may correspond to a point A₂, a projection of the point A₂ on the perpendicular bisector plane S₁ is a point A₂′, and the angle between the connecting line between the midpoint M and the first microphone (i.e., the point A₂) and the perpendicular bisector plane S₁ (i.e., an angle ∠A₂MA₂′) may have a negative value. Of course, in other embodiments, it could also be that when the first microphone is located on the side of the perpendicular bisector plane S₁ close to the pressure relief hole 1112, the angle between the connecting line between the midpoint M and the first microphone and the perpendicular bisector plane S₁ has a negative value. When the first microphone is located on the side of the perpendicular bisector plane S₁ close to the sound outlet hole 1111, the angle between the connecting line between the midpoint M and the first microphone and the perpendicular bisector plane S₁ has a positive value.

In some embodiments, please refer to FIGS. 4, 5, and 6, in the wearing state, the free end FE of the sound output unit 11 may extend into the concha cavity and abut against the concha cavity, a side of the ear hook 12 close to the head of the user has a first contact point D in contact with the head of the user, and a side of the ear hook 12 close to the sound output unit 11 has a second contact point E in contact with the auricle of the user. The second contact point E may cooperate with the free end FE to achieve clamping of the sound output device 10.

In some embodiments, an absolute value of a difference between a distance from the first microphone (i.e., the point A) to the first contact point D (i.e., a length of a connecting line AD) and a distance from the first microphone (i.e., the point A) to the second contact point E point (i.e., a length of a connecting line AE) is less than 1 mm. That is, an absolute value of a difference between the length of the connecting line AD and the length of the connecting line AE is less than 1 mm. Through the above settings, the distances from the first microphone to the first contact point D and the second contact point E may be made similar, that is, the first microphone may be located near a perpendicular bisector plane of a connecting line between the first contact point D and the second contact point E. At this time, the first microphone is simultaneously far from the first contact point D and the second contact point E, so that the first microphone is far from the head skin or the auricle of the user, to reduce the echo caused by the interference of the head skin or the auricle of the user on the first microphone. In some embodiments, to further enable the first microphone to have a large spacing from both the first contact point D and the second contact point E simultaneously, the first microphone may be set close to the perpendicular bisector plane of the connecting line between the first contact point D and the second contact point E, and the absolute value of the difference between the length of the connecting line AD and the length of the connecting line AE may be less than 0.8 mm. In some embodiments, to further set the first microphone close to the perpendicular bisector plane of the connecting line between the first contact point D and the second contact point E, the absolute value of the difference between the length of the connecting line AD and the length of the connecting line AE may be less than 0.5 mm.

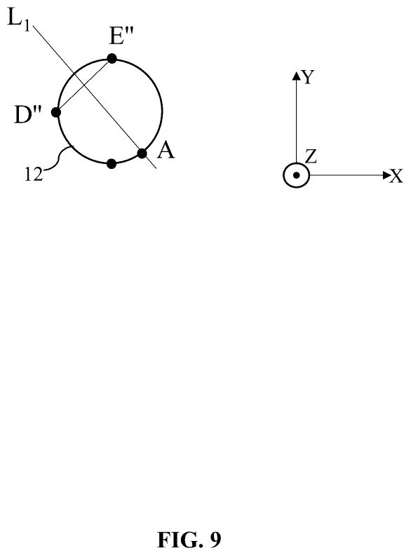

FIG. 9 is a schematic diagram illustrating a cross-section of an ear hook at a first microphone according to some embodiments of the present disclosure. Please refer to FIG. 9, a point D″ is a projection point of the first contact point D on the cross-section of the ear hook at the first microphone, a point E″ is a projection point of the second contact point E on the cross-section of the ear hook at the first microphone, and a straight line L₁ is an intersection line of the perpendicular bisector plane of the connecting line between the first contact point D and the second contact point E and the cross-section of the ear hook at the first microphone. In some embodiments, the straight line L₁ may be a projection of a perpendicular bisector plane of a connecting line between the point D″ and the point E″ on the cross-section of the ear hook at the first microphone. As shown in FIG. 9, the point A may be set close to the straight line L₁. Correspondingly, the first microphone is set close to the perpendicular bisector plane of the connecting line between the first contact point D and the second contact point E.

Please refer to FIGS. 4 and 5, in some embodiments, in the long axis direction Y of the sound output unit 11, the ear hook 12 has an outermost end (i.e., the point H). In some embodiments, an outer contour of the ear hook 12 has a tangent plane perpendicular to the long axis direction Y at the outermost end (i.e., the point H), and a projection of the tangent plane on the sagittal axis is a straight line L₂. That is, the straight line L₂ is tangent to the ear hook 12 at the outermost end (i.e., the point H).

In some embodiments, the outermost end (i.e., the point H) may also be determined by other manners. Exemplarily, a reference point (e.g., the centroid of the sound output unit 11) may be taken as an origin, the long axis direction Y may be taken as a horizontal axis, and another direction (e.g., the short axis direction Z) may be taken as a vertical axis to establish a coordinate system, and a simulated curve of the outer contour of the ear hook 12 may be imported. Then, a point on the simulated curve with the smallest horizontal coordinate may correspond to the outermost end (i.e., the point H).

In some embodiments, a distance from the first microphone (i.e., the point A) to the outermost end (i.e., the point H), i.e., a length of a connecting line AH, may be less than or equal to 2 mm, so that the first microphone may be far from the inner contour on the ear hook 12 close to the auricle of the user in the wearing state, thereby making the first microphone far from the auricle of the user, reducing the echo caused by the interference of the user's ear on the first microphone, and improving the output effect of the sound output device 10. In some embodiments, to further make the first microphone far from the user's ear and reduce the interference of the user's ear on the first microphone, the distance from the first microphone to the outermost end (i.e., the length of the connecting line AH) may be less than or equal to 1.5 mm. In some embodiments, to further make the first microphone far from the head skin of the user and reduce the echo, the distance from the first microphone to the outermost end (i.e., the length of the connecting line AH) may be less than or equal to 1 mm.

If an area of the cross-section of the ear hook 12 near the point A is very small, then because the ear hook 12 abuts against the back side of the auricle or the head skin when worn, a distance from the point A to the back side of the auricle or the head skin may be too small, affecting the sound pickup effect of the first microphone. To avoid the above problems, an area of the cross-section at the first microphone on the ear hook 12 may meet a certain condition. Please refer to FIG. 9, the first microphone is disposed at a first position (i.e., the point A) of the ear hook 12, and an area of the cross-section of the ear hook 12 at the first position is in a range of 75 mm² to 250 mm², so that the ear hook 12 has sufficient structural strength while the first microphone may be far from the user's ear, reducing the echo and improving the output effect of the sound output device 10. In some embodiments, to further ensure that the ear hook 12 has sufficient structural strength, the area of the cross-section of the ear hook 12 at the first position may be in a range of 100 mm² to 200 mm². In some embodiments, to make the first microphone further away from the user's ear and head skin, the area of the cross-section of the ear hook 12 at the first position may be in a range of 125 mm² to 175 mm².

In some embodiments, a shape of the cross-section of the ear hook 12 may be circular, that is, the ear hook 12 as a whole may be cylindrical, making the ear hook 12 smooth and without edges, improving the wearing comfort of the ear hook 12. In some embodiments, to make the first microphone far from the user's ear and head skin and reduce the echo, a radius of the cross-section of the ear hook 12 at the first position may be in a range of 5 mm to 7 mm.

In some embodiments, the first microphone (i.e., the point A) may be disposed in the accommodation cavity 123, and the accommodation cavity 123 may protect the first microphone. Furthermore, compared to a size at other positions on the ear hook 12, the accommodation cavity 123 has a larger size, which can make the first microphone far from the user's ear and head skin, reduce the echo, and improve the output effect of the sound output device 10.

In some embodiments, please refer to FIG. 6, the ear hook 12 includes an ear hook plane S₂. In some embodiments, the ear hook plane S₂ is a plane formed by three most convex points on the ear hook 12, that is, the plane that supports the ear hook 12 when the ear hook 12 is freely placed (i.e., not subject to external forces). For example, when the ear hook 12 is freely placed on the horizontal plane, the horizontal plane supports the ear hook 12, and the horizontal plane may be regarded as the ear hook plane S₂. In other embodiments, the ear hook plane S₂ also refers to a plane constituted by a bisector that bisects or approximately bisects the ear hook 12 along a length extension direction of the ear hook 12. In the wearing state, the ear hook 12 may be approximately regarded as fitting with the head, and the ear hook plane S₂ may be approximately equivalent to a fitting surface between the ear hook 12 and the head of the user. A distance from the first microphone to the ear hook plane S₂ may reflect a distance between the first microphone and the head of the user. If the distance from the first microphone to the ear hook plane S₂ is too small, the head skin of the user may cause interference to the first microphone, generating the echo and affecting the output effect of the sound output device 10. In some embodiments, the distance from the first microphone (i.e., the point A) to the ear hook plane S₂ is greater than 10 mm.

In some embodiments, to further reduce the echo, the distance from the first microphone to the ear hook plane S₂ may be greater than 12 mm. In some embodiments, to further reduce the echo, the distance from the first microphone to the ear hook plane S₂ may be greater than 15 mm.

In some embodiments, the one or more microphones may include a microphone array formed by at least two microphones. For example, the one or more microphones may include a second microphone (not shown in the figure) and a third microphone (not shown in the figure). The second microphone and the third microphone may respectively collect the ambient sound and generate the electric signal. The processing circuit may primarily identify a sound from a specific direction range (e.g., a direction indicated by a connecting line between the two microphones) based on the electric signal collected by the microphone array and further process (e.g., amplify) the sound from the specific direction. In some embodiments of the present disclosure, the point B may be used to represent a position of the second microphone, and the point C may be used to represent a position of the third microphone, as shown in FIGS. 3, 4, and 5.

Please refer to FIGS. 3, 4, and 5, in some embodiments, the second microphone (i.e., the point B) and the third microphone (i.e., the point C) are both disposed on the ear hook 12, the second microphone (i.e., the point B) is located at the front side of the third microphone (i.e., the point C), and a connecting line (i.e., the connecting line CP) between the third microphone (i.e., the point C) and the sound outlet hole 1111 (i.e., the point P) passes through the auricle of the user, so that the sound output by the sound output unit 11 is blocked by the auricle, reducing the sound output by the sound output unit 11 that is received by the third microphone, reducing the generation of the echo, and at the same time, the auricle can block wind, reducing the wind noise received by the third microphone, thereby improving the output effect of the sound output device 10. The front side refers to a direction from the back of the head towards the user's face.

To reduce the sound output by the sound output unit 11 that is collected by the second microphone and the third microphone and to reduce the echo, the sound output unit 11 may be designed so that the sound field of the sound output unit 11 exhibits the directivity, having a larger output only in a direction from the sound output unit 11 pointing to the opening of the ear canal, while having a smaller sound leakage in other directions. For example, the sound field of the sound output unit 11 may be made to exhibit the cardioid directivity, with a direction of the cardioid directivity being the direction from the sound output unit 11 to the opening of the ear canal (e.g., a direction from the point Q (the centroid of the pressure relief hole 1112) to the point P (the centroid of the sound outlet hole 1111)).

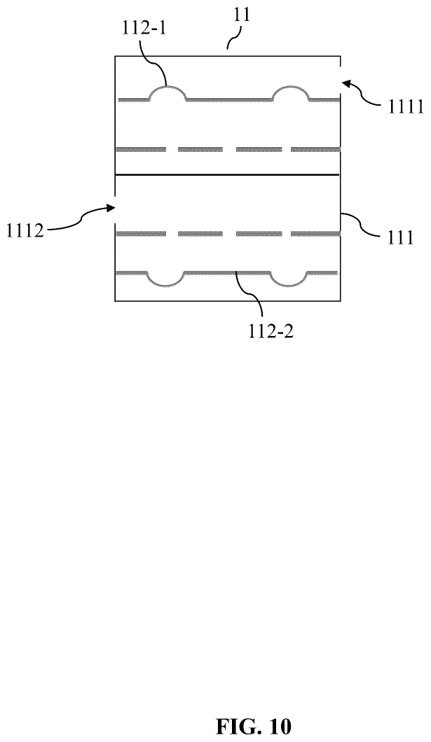

FIG. 10 is a schematic diagram illustrating an internal structure of a sound output unit according to some embodiments of the present disclosure. Please refer to FIG. 10, in some embodiments, the sound output unit 11 may include a first diaphragm 112-1 and a second diaphragm 112-2. The first diaphragm 112-1 outputs a sound through the sound outlet hole 1111, and the second diaphragm 112-2 outputs a sound through the pressure relief hole 1112. In some embodiments, the processing circuit may process the electric signals generated by the second microphone and the third microphone, respectively, and the first diaphragm 112-1 and the second diaphragm 112-2 may generate sounds based on the processed electric signals, respectively. Exemplarily, a processed electric signal of the second microphone may be used as an excitation for the first diaphragm 112-1, causing the first diaphragm 112-1 to produce a sound corresponding to the electric signal output by the second microphone. A processed electric signal of the third microphone may be used as an excitation for the second diaphragm 112-2, causing the second diaphragm 112-2 to produce a sound corresponding to the electric signal output by the third microphone.

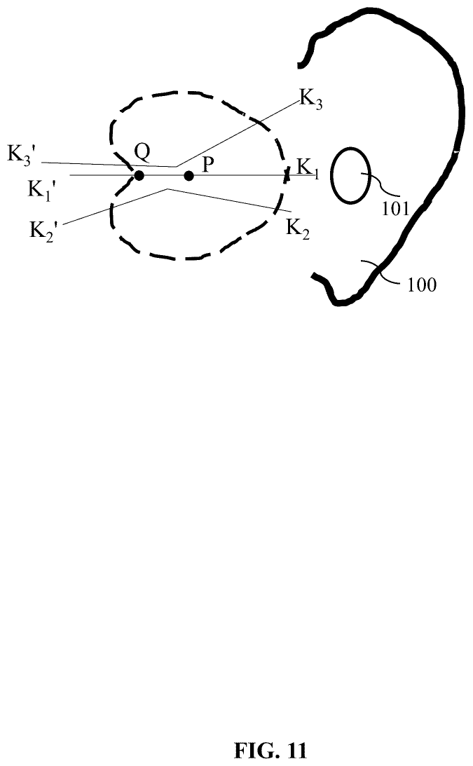

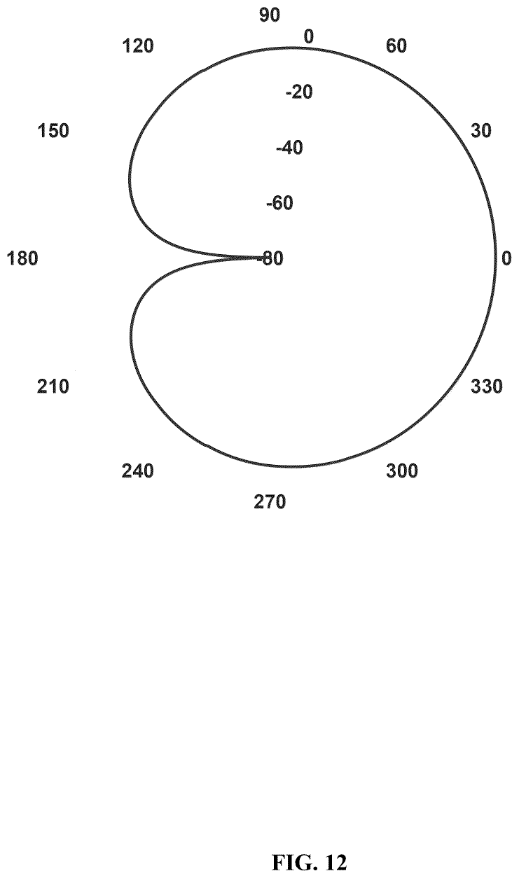

FIG. 11 is a schematic diagram illustrating directivity of a sound output unit according to some embodiments of the present disclosure. FIG. 12 is a schematic diagram illustrating another sound field distribution for sound pressure levels of a sound output unit according to some embodiments of the present disclosure.

Please refer to FIGS. 11 and 12, in some embodiments, the sound output unit 11 shown in FIG. 11 is in the wearing state, where the point P represents the sound outlet hole 1111 through which the first diaphragm 112-1 outputs a sound, and the point Q represents the pressure relief hole 1112 through which the second diaphragm 112-2 outputs a sound. In some embodiments, sounds radiated to the far field of the sound output device 10 by the sound outlet hole 1111 and the pressure relief hole 1112 exhibit directivity, and in a target frequency range, an absolute value of a difference between sound pressure levels (SPL) of the sound output device 10 at two far-field positions, one in a specific direction and the other in an opposite direction of the specific direction, is more than or equal to 6 dB. A connecting line between the sound outlet hole 1111 and the pressure relief hole 1112 (i.e., the connecting line QP) defines the specific direction.

In some embodiments, a far-field radiation of the sound output device 10 exhibiting directivity means that an output sound direction of the sound output device 10 is within a specified direction range, that is, a far-field radiation of the sound output device 10 within the specified direction range is significantly greater than a far-field radiation of the sound output device outside the specified direction range. In some embodiments, in the wearing state of the sound output device 10, a direction K₁ from the pressure relief hole 1112 (i.e., the point Q) to the sound outlet hole 1111 (i.e., the point P), i.e., the direction K₁ from the point Q to the point P, and nearby directions of the direction K₁ (e.g., a direction K₂, a direction K₃), point to the opening of the ear canal of the user. That is, in the wearing state, the sound outlet hole 1111 is closer to the opening of the ear canal of the ear. A direction K₁′ from the sound outlet hole 1111 (i.e., the point P) to the pressure relief hole 1112 (i.e., the point Q) and nearby directions of the direction K₁′ (e.g., a direction K₂′, a direction K₃′) are directions in which the sound output unit 11 faces away from the opening of the ear canal. In some embodiments, in the wearing state and/or the non-wearing state, the direction K₁ from the pressure relief hole 1112 (i.e., the point Q) to the sound outlet hole 1111 (i.e., the point P), i.e., the direction K₁ from the point Q to the point P, and the nearby directions of the direction K₁, may constitute the specified direction range. Far-field radiations of the sound output device 10 in the direction K₁ and the nearby directions of the direction K₁ are significantly greater than far-field radiations in other direction ranges (e.g., direction ranges perpendicular to the direction K₁ and the nearby directions of the direction K₁, direction ranges opposite to the direction K₁ and the nearby directions of the direction K₁, etc.). In some embodiments, the directivity of the sound output device 10 may be manifested as: the absolute value of the difference between the sound pressure levels of the sound output device 10 at the two far-field positions, one in the specific direction and the other in the opposite direction of the specific direction, is more than or equal to 6 dB. In the wearing state, the specific direction refers to the direction in which the sound output device 10 (the sound output unit 11) faces away from the opening of the ear canal, and the opposite direction of the specific direction refers to a direction in which the sound output device 10 (the sound output unit 11) points to the ear canal of the user. In some embodiments, the specific direction refers to the direction K₁′ from the sound outlet hole 1111 (i.e., the point P) to the pressure relief hole 1112 (i.e., the point Q) and the nearby directions of the direction K₁′. The opposite direction of the specific direction refers to the direction K₁ from the pressure relief hole 1112 (i.e., the point Q) to the sound outlet hole 1111 (i.e., the point P), i.e., the direction K₁ from the point Q to the point P, and the nearby directions of the direction K₁. In some embodiments, the nearby directions of the direction K₁′ may be understood as directions whose angles are less than 60° from the direction K₁′. It should be known that, for the purpose of conveniently understanding directivity, only the two hole portions, i.e., the sound outlet hole 1111 and the pressure relief hole 1112, are used here for exemplary explanation. When there are more different hole portions in the sound output unit 11 of the sound output device 10, the point P may be understood as the centroid of the equivalent hole portion formed by a plurality of sound outlet holes 1111, and the point Q may be understood as the centroid of the equivalent hole portion formed by a plurality of pressure relief holes 1112.

In some embodiments, the first diaphragm 112-1 and the second diaphragm 112-2 vibrate asynchronously, and a first sound generated by the first diaphragm 112-1 and a second sound generated by the second diaphragm 112-2 have a phase difference, so that the first sound and the second sound may superimpose and enhance each other on a side of the sound output unit 11 facing the ear canal of the user, and superimpose and cancel each other out on a side of the sound output unit 11 facing away from the ear canal of the user, thereby causing the sound field of the sound output unit 11 (the sound output device 10) to exhibit the cardioid directivity.

In some embodiments, the far-field radiation of the sound output device 10 exhibiting the cardioid directivity may be manifested as: within the specified direction range, the absolute value of the difference in sound pressure levels of far-field radiated sounds of the sound output device 10 in at least one pair of opposite directions is more than or equal to 6 dB, so that a larger volume may be received at the opening of the ear canal, allowing the user to obtain a clear listening effect. The at least one pair of opposite directions may respectively fall within the specified direction range and an opposite direction range of the specified direction range. In some embodiments, the at least one pair of opposite directions may include the specific direction and the opposite direction of the specified direction. That is, the specific direction and the opposite direction of the specified direction may be included in the specified direction range and the opposite direction range of the specified direction range, respectively. In some embodiments, the at least one pair of opposite directions includes a pair of opposite directions corresponding to the connecting line between the sound outlet hole 1111 (i.e., the point P) and the pressure relief hole 1112 (i.e., the point Q). The cardioid directivity of the sound output device 10 may be manifested as a large difference in sound field strengths between a pair of opposite or nearly opposite directions within the specified direction range and the opposite direction range of the specified direction range. Exemplarily, the pair of opposite or nearly opposite directions may mean that one direction is located near the direction K₁′ from the sound outlet hole 1111 (i.e., the point P) to the pressure relief hole 1112 (i.e., the point Q), and the other direction is located near the direction K₁ from the pressure relief hole 1112 (i.e., the point Q) to the sound outlet hole 1111 (i.e., the point P). For example, the direction K₁′ may be opposite or nearly opposite to the direction K₁, the direction K₂, and the direction K₃.

In some embodiments, to improve the sound reception effect for the user, the sound output device 10 may exhibit the cardioid directivity in frequency ranges sensitive to the human ear, such as around 3 kHz or 3.5 kHz. The target frequency range may be 1 kHz to 4 kHz.

Please refer to FIGS. 11 and 12, in the cardioid directivity of the sound field of the sound output unit 11, a maximum point of the sound field is near the 0° direction, and a minimum point of the sound field is near the 180° direction. In some embodiments, the connecting line between the point P (the centroid of the sound outlet hole 1111) and the point Q (the centroid of the pressure relief hole 1112), i.e., the connecting line PQ, lies on a straight line of the 0° direction and the 180° direction.

To reduce the sound output by the sound output unit 11 that is collected by the second microphone and the third microphone and to reduce the generation of the echo, the second microphone and the third microphone may be set in the low sound leakage region, that is, the second microphone and the third microphone may be set near the 180° direction of the cardioid directivity of the sound field of the sound output unit 11. In some embodiments, considering the structure and positional arrangement of the ear hook 12 and the sound output unit 11, the second microphone (i.e., the point B) and the third microphone (i.e., the point C) are set on the ear hook 12 on the ear hook 12 located at side of the sound output unit 11 where the sound outlet hole 1111 (i.e., the point P) points to the pressure relief hole 1112 (i.e., the point Q), that is, the points B and C are set on the ear hook 12 located at an upper side of the sound output unit 11. In some embodiments, an angle between a connecting line between the second microphone (i.e., the point B) and the midpoint M and the connecting line (i.e., the connecting line PQ) between the point P (the centroid of the sound outlet hole 1111) and the point Q (the centroid of the pressure relief hole 1112), i.e., an angle ∠BMQ, is in a range of 0° to 30°. In some embodiments, an angle between a connecting line between the third microphone (i.e., the point C) and the midpoint M and the connecting line (i.e., the connecting line PQ) between the point P (the centroid of the sound outlet hole 1111) and the point Q (the centroid of the pressure relief hole 1112), i.e., an angle ∠CMQ, is in a range of −30° to 0°.

In some embodiments, to further reduce the echo, the angle between the connecting line between the second microphone and the midpoint M and the connecting line between the centroid of the sound outlet hole 1111 and the centroid of the pressure relief hole 1112 (i.e., the angle ∠BMQ) may be in a range of 0° to 20°. In some embodiments, to further reduce the echo, the angle between the connecting line between the second microphone and the midpoint M and the connecting line between the centroid of the sound outlet hole 1111 and the centroid of the pressure relief hole 1112 (i.e., the angle ∠BMQ) may be in a range of 0° to 10°.

In some embodiments, to further reduce the echo, the angle between the connecting line between the third microphone and the midpoint M and the connecting line between the centroid of the sound outlet hole 1111 and the centroid of the pressure relief hole 1112 (i.e., the angle ∠CMQ) may be in a range of −20° to 0°. In some embodiments, to further reduce the echo, the angle between the connecting line between the third microphone and the midpoint M and the connecting line between the centroid of the sound outlet hole 1111 and the centroid of the pressure relief hole 1112 (i.e., the angle ∠CMQ) may be in a range of −10° to 0°.

In some embodiments, the positive or negative values of the aforementioned two angles (i.e., the angle ∠BMQ and the angle ∠CMQ) may indicate which side of the connecting line between the centroid of the sound outlet hole 1111 and the centroid of the pressure relief hole 1112 (i.e., the connecting line PQ) the corresponding microphone is located on. Specifically, please refer to FIG. 4, when the second microphone (i.e., the point B) is located on a side of the connecting line PQ pointing to the user's face (e.g., a side away from the free end FE), the angle between the connecting line between the second microphone and the midpoint M and the connecting line between the centroid of the sound outlet hole 1111 and the centroid of the pressure relief hole 1112 may have a positive value. When the third microphone (i.e., the point C) is located on a side of the connecting line PQ pointing to the back of the head of the user (e.g., a side towards the free end FE), the angle between the connecting line between the third microphone and the midpoint M and the connecting line between the centroid of the sound outlet hole 1111 and the centroid of the pressure relief hole 1112 may have a negative value. Of course, in other embodiments, it could also be that when the second microphone is located on the side of the connecting line PQ pointing to the back of the head of the user, the angle between the connecting line between the second microphone and the midpoint M and the connecting line between the centroid of the sound outlet hole 1111 and the centroid of the pressure relief hole 1112 has a negative value. When the third microphone is located on the side of the connecting line PQ pointing to the user's face, the angle between the connecting line between the third microphone and the midpoint M and the connecting line between the centroid of the sound outlet hole 1111 and the centroid of the pressure relief hole 1112 has a positive value.

It should be noted that the second microphone (i.e., the point B), the third microphone (i.e., the point C), the point P, the centroid of the sound outlet hole 1111, and the point Q, the centroid of the pressure relief hole 1112, may be coplanar or non-coplanar, and the angle ∠BMQ corresponding to the second microphone and the angle ∠CMQ corresponding to the third microphone may be measured in different planes respectively.

Furthermore, please refer to FIGS. 4 and 5, by setting the second microphone and the third microphone on opposite sides of the connecting line between the centroid of the sound outlet hole 1111 and the centroid of the pressure relief hole 1112, the connecting line between the second microphone and the third microphone can be made to point to the front of the user, to better collect the sound produced by a conversation partner of the user.

Please refer to FIG. 5, the projection of the ear hook 12 on the sagittal plane includes an outer contour, namely curve J₁J₂, and an inner contour, namely curve J₃J₄. A point J₁ is an intersection point of the outer contour of the ear hook 12 and the sound output unit 11, a point J₃ is an intersection point of the inner contour of the ear hook 12 and the sound output unit 11, a point J₂ is an endpoint of an end of the accommodation cavity 123 close to the free end of the ear hook 12, which is located on the outer contour of the ear hook 12, and a point J₄ is an endpoint of the end of the accommodation cavity 123 close to the free end of the ear hook 12, which is located on the inner contour of the ear hook 12. In some embodiments, in the short axis direction Z of the projection of the sound output unit 11 on the sagittal plane, the outer contour curve J₁J₂ may have an extreme point N. In some embodiments, a reference coordinate system may be established with a reference point (e.g., the centroid of the sound output unit 11) as an origin, the long axis direction Y as a horizontal axis, and the short axis direction Z as a vertical axis. The outer contour curve J₁J₂ of the ear hook 12 may be analyzed under the reference coordinate system to determine the extreme point N of the outer contour curve J₁J₂ of the ear hook 12 in the short axis direction Z.

In some embodiments, a projection (i.e., the point B′) of the second microphone on the sagittal plane and a projection (i.e., the point C′) of the third microphone on the sagittal plane may be respectively located on two sides of the extreme point N of the outer contour of the ear hook 12, so that the connecting line between the second microphone and the third microphone may point to the front of the user, to better collect the sound produced by the conversation partner.

In some embodiments, the second microphone (i.e., the point B) may be located at the front side of the auricle of the user. That is, the second microphone is located on the side of the auricle of the user facing the user's face, so that the second microphone is not blocked by the auricle of the user (as shown in FIG. 4), to improve the pickup effect of the second microphone for ambient sound. Furthermore, the second microphone being located at the front side of the auricle of the user also allows the second microphone to be close to the user's face, to better collect the sound produced by the conversation partner located in front of the user.

In some embodiments, in the wearing state, the projection (i.e., the point B′) of the second microphone on the sagittal plane is located outside the projection of the auricle of the user on the sagittal plane, so that the second microphone is not blocked by the auricle of the user, to improve the pickup effect of the second microphone for ambient sound.

Since the second microphone is located at the front side of the auricle of the user, the second microphone is not blocked by the auricle, and the connecting line between the second microphone (i.e., the point B) and the point P (the centroid of the sound outlet hole 1111) may not pass through the auricle. There is no auricle blocking between the sound outlet hole 1111 and the second microphone, and the sound output by the sound outlet hole 1111 may be directly transmitted to the second microphone. To minimize the sound output by the sound output unit 11 that is received by the second microphone, the second microphone may be set in the low sound leakage region of the sound field of the sound output unit 11.

Since the connecting line between the third microphone and the point P (the centroid of the sound outlet hole 1111) passes through the auricle, the sound output by the sound output unit 11 is blocked by the auricle, and the third microphone receives less sound output by the sound output unit 11. It is feasible to determine whether the third microphone is set in the low sound leakage region of the sound field of the sound output unit 11 or not.

In some embodiments, the angle between the connecting line between the second microphone and the midpoint M and the connecting line between the centroid of the sound outlet hole 1111 and the centroid of the pressure relief hole 1112 (i.e., the angle ∠BMQ) may be greater than the angle between the connecting line between the third microphone and the midpoint M and the connecting line between the centroid of the sound outlet hole 1111 and the centroid of the pressure relief hole 1112 (i.e., the angle ∠CMQ), as shown in FIG. 4, so that the second microphone is set in the low sound leakage region of the sound field of the sound output unit 11, and the third microphone may be set in the high sound leakage region of the sound field of the sound output unit 11.

In some embodiments, please refer to FIG. 4, in the wearing state, an angle α between the connecting line between the second microphone and the third microphone (i.e., the connecting line BC) and the sagittal axis may be in the range of −30° to 30°, so that the connecting line between the second microphone and the third microphone points to the front of the user, to better collect the sound produced by the conversation partner located in front of the user. In some embodiments, to improve the collection effect of the second microphone and the third microphone for the sound produced by the conversation partner, the angle α between the connecting line between the second microphone and the third microphone (i.e., the connecting line BC) and the sagittal axis may be in a range of −10° to 10°. In some embodiments, to further improve the collection effect of the second microphone and the third microphone for the sound output by a sound source in front of the user, the angle α between the connecting line between the second microphone and the third microphone (i.e., the connecting line BC) and the sagittal axis may be in a range of −5° to 5°.

In some embodiments, the positive or negative value of the angle α between the connecting line between the second microphone and the third microphone (i.e., the connecting line BC) and the sagittal axis may indicate an orientation of a connecting line CB between the second microphone and the third microphone. Exemplarily, when the angle α has a positive value, it may indicate that a direction from the point C to the point B is upward front, i.e., pointing towards the head of the user top and the front of the user. When the angle α has a negative value, it may indicate that the direction from the point C to the point B is downward front, i.e., pointing towards the user's mouth and the front of the user.

In some embodiments, please refer to FIGS. 2 and 4, the long axis direction Y of the sound output unit 11 and the sagittal axis may be parallel, inclined, or perpendicular to each other. An angle between the connecting line between the second microphone and the third microphone (i.e., the connecting line CB) and the long axis direction Y of the sound output unit 11 may also reflect the directivity of the connecting line between the second microphone and the third microphone (i.e., the connecting line CB). In some embodiments, an angle β between the connecting line between the second microphone and the third microphone (i.e., the connecting line CB) and the long axis direction Y of the sound output unit 11 is in a range of −30° to 30°, so that the connecting line between the second microphone and the third microphone points to the front of the user, to better collect the sound produced by the conversation partner located in front of the user. It should be noted that when the sound output unit 11 is in different positional states (corresponding to different inclination angles γ of the long axis direction Y of the sound output unit 11 relative to the sagittal axis), a value range of the angle β between the connecting line between the second microphone and the third microphone (i.e., the connecting line CB) and the long axis direction Y of the sound output unit 11 may be different. Exemplarily, when the sound output unit 11 is in a position shown as the sound output unit 11C in FIG. 2, the long axis direction Y is parallel to the sagittal axis, and at this time, the angle β between the connecting line between the second microphone and the third microphone (i.e., the connecting line CB) and the long axis direction Y of the sound output unit 11 may be in the range of −30° to 30°. When the sound output unit 11 is in a position shown as the sound output unit 11A in FIG. 2, the long axis direction Y is perpendicular to the sagittal axis, and at this time, the angle β between the connecting line between the second microphone and the third microphone (i.e., the connecting line CB) and the long axis direction Y of the sound output unit 11 may be in a range of 60° to 120°. Specifically, the angle β between the connecting line between the second microphone and the third microphone (i.e., the connecting line CB) and the long axis direction Y of the sound output unit 11 depends on the inclination angle γ of the long axis direction Y relative to the sagittal axis. When the inclination angle γ is positive, it indicates that the long axis direction Y is inclined upward relative to the sagittal axis, and at this time, the value of the angle β is the angle α minus the angle γ, where the angle α is in the range of −30° to 30°. When the angle γ is negative, it indicates that the long axis direction Y is inclined downward relative to the sagittal axis, and at this time, the value of β is the angle α plus the angle γ, where the angle α is in the range of −30° to 30°.

In some embodiments, a distance between the second microphone and the third microphone (i.e., a length of the connecting line BC) may be in a range of 5 mm to 20 mm, so that there is no auricle isolation between the second microphone and the third microphone, while the sound produced by the conversation partner in front of the user has a time difference between reaching the second microphone and reaching the third microphone, causing a large phase difference and a small amplitude difference between the sound collected by the second microphone and the sound collected by the third microphone, to facilitate differential processing and improve the collection effect for the sound produced by the conversation partner in front of the user.

If the distance between the second microphone and the third microphone is too small, it may cause the time difference between the sound signals received by the second microphone and the third microphone to be too small, and the phase difference between the sounds received by the second microphone and the third microphone may be small, resulting in poor differential processing effect and less than ideal collection effect. If the distance between the second microphone and the third microphone is too large, it may cause the second microphone and the third microphone to be isolated by the auricle, resulting in the large phase difference and a large amplitude difference between the sound collected by the second microphone and the sound collected by the third microphone, making differential processing difficult and ineffective, and the collection effect is poor.

In some embodiments, to further reduce the amplitude difference between the sound signals collected by the second microphone and the third microphone, the distance between the second microphone and the third microphone (i.e., the length of the connecting line BC) may be in a range of 10 mm to 15 mm. In some embodiments, to further increase the phase difference between the sound signals collected by the second microphone and the third microphone, the distance between the second microphone and the third microphone (i.e., the length of the connecting line BC) may be in a range of 12 mm to 13 mm.

In some embodiments, please refer to FIG. 5, the projection (i.e., the point B′) of the second microphone on the sagittal plane and the projection (i.e., the point C′) of the third microphone on the sagittal plane are both set closer to the outer contour (i.e., the curve J₁J₂) than to the inner contour of the ear hook 12 (i.e., the curve J₃J₄). That is, on the ear hook 12, both the second microphone and the third microphone are set on the side of the ear hook 12 away from the auricle of the user, so that the second microphone and the third microphone may be far away from the head skin of the user, reducing the interference from the user's skin, reducing the echo, and improving the output effect of the sound output device 10.

The basic concepts have been described above, and obviously, for those skilled in the art, the above detailed disclosure is merely an example and does not constitute a limitation to the present disclosure. Although not explicitly stated here, those skilled in the art may make various modifications, improvements, and amendments to the present disclosure. Such modifications, improvements, and amendments are suggested in the present disclosure, so they still fall within the spirit and scope of the exemplary embodiments of the present disclosure.

Meanwhile, the present disclosure uses specific words to describe the embodiments of the present disclosure. For example, “one embodiment”, “an embodiment”, and/or “some embodiments” mean a certain feature, structure, or characteristic related to at least one embodiment of the present disclosure. Therefore, it should be emphasized and noted that “an embodiment” or “one embodiment” or “an alternative embodiment” mentioned twice or more in different places in the present disclosure does not necessarily refer to the same embodiment. In addition, some features, structures, or characteristics in one or more embodiments of the present disclosure can be appropriately combined.

Similarly, it should be noted that, in order to simplify the expression of the disclosure of the present disclosure and thereby help the understanding of one or more inventive embodiments, in the foregoing description of the embodiments of the present disclosure, sometimes multiple features are incorporated into one embodiment, drawing, or its description. However, this manner of disclosure does not mean that the object of the present disclosure requires more features than those mentioned in the claims. In fact, the features of the embodiments are fewer than all the features of the single embodiments disclosed above.

Some embodiments use numbers describing components and attribute quantities. It should be understood that such numbers used in the description of the embodiments are modified by the modifiers “about”, “approximately”, or “substantially” in some examples. Unless otherwise stated, “about”, “approximately”, or “substantially” indicates that the number allows a variation of ±20%. Accordingly, in some embodiments, the numerical parameters used in the present disclosure and claims are all approximate values, and these approximate values may change according to the characteristics required by individual embodiments. In some embodiments, numerical parameters should consider the specified significant digits and adopt the manner of general digit retention. Although the numerical ranges and parameters used to confirm their scope breadth in some embodiments of the present disclosure are approximate values, in specific embodiments, the setting of such numerical values is as precise as possible within the feasible range.

For each patent, patent application, patent application publication, and other materials cited in the present disclosure, such as articles, books, specifications, publications, documents, etc., their entire contents are hereby incorporated into the present disclosure by reference. Except for application history documents that are inconsistent with or conflict with the content of the present disclosure, documents that limit the broadest scope of the claims of the present disclosure (currently or subsequently appended to the present disclosure) are also excluded. It should be noted that if the description, definition, and/or use of terms in the ancillary materials of the present disclosure are inconsistent or conflict with the content described in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, as an example rather than a limitation, alternative configurations of the embodiments of the present disclosure can be considered consistent with the teachings of the present disclosure. Accordingly, the embodiments of the present disclosure are not limited to the embodiments explicitly introduced and described in the present disclosure.

1. A sound output device, comprising:
a sound output unit, including a housing and a diaphragm disposed in the housing, wherein a front cavity and a rear cavity are respectively provided on two sides of the diaphragm in the housing, the front cavity is acoustically coupled to a sound outlet hole provided on the housing, the sound outlet hole is disposed toward an ear canal of a user, and the rear cavity is acoustically coupled to a pressure relief hole provided on the housing;
an ear hook, including a first portion and a second portion, wherein the first portion is located between an auricle and a head of the user, and the second portion extends toward a side of the auricle away from the head and is connected to the sound output unit, to the ear hook places the sound output unit near the ear canal without blocking an opening of the ear canal;
one or more microphones, disposed on the ear hook, configured to collect an ambient sound to generate an electric signal; and
a processing circuit, configured to perform an amplifying processing on the electric signal generated by the one or more microphones and send a processed electric signal to the sound output unit, and the sound output unit generates a sound under an action of the processed electric signal; wherein,
at least one of the one or more microphones is located at the first portion of the ear hook, and a connecting line between the at least one of the one or more microphones and the sound outlet hole passes through the auricle.

2. The sound output device of claim 1, wherein the one or more microphones include a first microphone, and a ratio of a distance from the first microphone to a centroid of the sound outlet hole to a distance from the first microphone to a centroid of the pressure relief hole is in a range of 0.8 to 1.2.

3. The sound output device of claim 1, wherein the one or more microphones include a first microphone, a connecting line between a centroid of the sound outlet hole and a centroid of the pressure relief hole has a midpoint and defines a perpendicular bisector plane passing through the midpoint, and an angle between a connecting line between the midpoint and the first microphone and the perpendicular bisector plane is in a range of −60° to 60°.

4. The sound output device of claim 1, wherein the one or more microphones include a first microphone, the first portion includes a first contact point in contact with the head of the user and a second contact point in contact with the auricle of the user, and an absolute value of a difference between a distance from the first microphone to the first contact point and a distance from the first microphone to the second contact point is less than 1 mm.

5. The sound output device of claim 1, wherein the one or more microphones include a first microphone, the ear hook has an outermost end in a long axis direction of the sound output unit, the outermost end is a tangent point at which an outer contour of the ear hook is tangent to an external tangent plane perpendicular to the long axis direction of the sound output unit, and a distance between the first microphone and the outermost end is less than or equal to 2 mm.

6. The sound output device of claim 1, wherein the one or more microphones include a first microphone, the first microphone is disposed at a first position of the ear hook, and an area of a cross-section of the ear hook at the first position is in a range of 75 mm² to 250 mm².

7. The sound output device of claim 1, wherein the one or more microphones include a first microphone, the first portion of the ear hook includes an accommodation cavity, and both the processing circuit and the first microphone are disposed in the accommodation cavity.

8. The sound output device of claim 1, wherein the one or more microphones include a first microphone, and a distance from the first microphone to an ear hook plane of the ear hook is greater than 10 mm.

9. The sound output device of claim 1, wherein the one or more microphones include a second microphone and a third microphone, the second microphone and the third microphone are both disposed on the ear hook, the second microphone is located at a front side of the third microphone, and a connecting line between the third microphone and the sound outlet hole passes through the auricle of the user.

10. The sound output device of claim 9, wherein a projection of the ear hook on a sagittal plane of the user includes an outer contour, in a short axis direction of a projection of the sound output unit on the sagittal plane, the outer contour has an extreme point, and a projection of the second microphone on the sagittal plane and a projection of the third microphone on the sagittal plane are located on two sides of the extreme point, respectively.

11. The sound output device of claim 9, wherein the second microphone is located at a front side of the auricle.

12. The sound output device of claim 9, wherein in a wearing state, a projection of the second microphone on a sagittal plane of the user is located outside a projection of the auricle on the sagittal plane.

13. The sound output device of claim 9, wherein in a wearing state, an angle between a connecting line between the second microphone and the third microphone and a sagittal axis of the user is in a range of −10° to 10°.

14. The sound output device of claim 9, wherein an angle between a connecting line between the second microphone and the third microphone and a long axis direction of the sound output unit is in a range of −30° to 30°.

15. The sound output device of claim 9, wherein a distance between the second microphone and the third microphone is in a range of 5 mm to 20 mm.

16. The sound output device of claim 9, wherein a projection of the ear hook on a sagittal plane of the user includes an outer contour and an inner contour, and a projection of the second microphone on the sagittal plane and a projection of the third microphone on the sagittal plane are both disposed closer to the outer contour than to the inner contour.

17. The sound output device of claim 9, wherein sounds radiated to a far field of the sound output device by the sound outlet hole and the pressure relief hole exhibits directivity, in a target frequency range, an absolute value of a difference between sound pressure levels (SPL) of the sound output device at two far-field positions, one in a specific direction and the other in an opposite direction of the specific direction, is more than or equal to 6 dB, and a connecting line between the sound outlet hole and the pressure relief hole defines the specific direction.

18. The sound output device of claim 17, wherein a connecting line between a centroid of the sound outlet hole and a centroid of the pressure relief hole has a midpoint, and an angle between a connecting line between the second microphone and the midpoint and the connecting line between the centroid of the sound outlet hole and the centroid of the pressure relief hole is in a range of 0° to 30°.

19. The sound output device of claim 17, wherein a connecting line between a centroid of the sound outlet hole and a centroid of the pressure relief hole has a midpoint, and an angle between a connecting line between the third microphone and the midpoint and the connecting line between the centroid of the sound outlet hole and the centroid of the pressure relief hole is in a range of −30° to 0°.

20. The sound output device of claim 1, wherein the one or more microphones include a first microphone, and a difference between a distance from the first microphone to a centroid of the sound outlet hole and a distance from the first microphone to a centroid of the pressure relief hole is less than 5 mm.
